(19) United States
(12) Patent Application Publication
(10) Pub. No.: US 2026/0132033 A1
(43) Pub. Date: May 14, 2026

(54) ACTIVATED CARBON FIBERS FOR FILTRATION AND METHODS OF MANUFACTURE

(71) Applicant: CARBON HOLDINGS INTELLECTUAL PROPERTIES, LLC, Ranchester, WY (US)

(72) Inventors: Charles Agee Atkins, Sheridan, WY (US); Charles Hill, Sheridan, WY (US)

(21) Appl. No.: 19/388,019

(22) Filed: Nov. 13, 2025

Related U.S. Application Data
(60) Provisional application No. 63/719,877, filed on Nov. 13, 2024.

(51) Int. Cl. C01B 32/318; B01D 53/04; B01J 20/20; B01J 20/28; B01J 20/34; C01B 32/336; C01B 32/348; D01D 5/098; D01F 9/145; D01F 11/16

(52) U.S. Cl. CPC C01B 32/318; B01D 53/0438; B01J 20/20; B01J 20/28023; B01J 20/28059; B01J 20/28061; B01J 20/28066; B01J 20/28085; B01J 20/3416; B01J 20/3441; C01B 32/336; C01B 32/348; D01D 5/0985; D01F 9/145; D01F 11/16; B01D 2253/102; B01D 2253/304; B01D 2253/306; B01D 2253/308; B01D 2257/504; B01D 2259/40096; C01P 2004/03; C01P 2006/12; D10B 2505/04

(57) ABSTRACT

Activated carbon fibers and methods of stabilizing, carbonizing, and activating carbon fibers are disclosed. The activated carbon fibers can be used in filtration, chemical capture, energy storage, and other applications. A method of producing an activated carbon fiber material for filtration or gas adsorption can include melt blowing pitch to form pitch fibers, stabilizing the pitch fibers to form stabilized pitch fibers, carbonizing the stabilized pitch fibers to form carbon fibers, and activating the carbon fibers to form activated carbon fibers with a specific surface area of at least 1900 m²/g.

### CROSS-REFERENCE TO RELATED APPLICATIONS

This application claims priority to U.S. Provisional Application No. 63/719,877, filed 13 Nov. 2024, the entire disclosure of which is hereby incorporated by reference.

### BACKGROUND

Coal tar pitch supply in the United States has declined. Factors contributing to this decline include ageing and less competitive coking operations, new coke ovens that do not produce coal tar pitch, and an increased steel production using electric arc furnaces that do not consume metallurgical coke. Uncertainty exists for the long-term availability of coal tar pitch as a material precursor for manufacturing carbonaceous products.

Therefore, creating opportunities for alternative processes that transform coal into carbon fibers and other value-added products is desired. This includes generating knowledge that will lead to scalable, efficient, cost-effective, and environmentally sustainable processes for manufacturing coal-derived carbon fibers.

### SUMMARY

An aspect of the present disclosure relates to a method of producing an activated carbon fiber material for filtration or gas adsorption. The method includes melt blowing pitch to form pitch fibers, stabilizing the pitch fibers to form stabilized pitch fibers, carbonizing the stabilized pitch fibers to form carbon fibers, and activating the carbon fibers to form activated carbon fibers. The activated carbon fibers have a specific surface area of at least 1900 m²/g.

In one or all examples, melt blowing the pitch can form the pitch fibers with diameters in a range from 1 μm to 20 μm. In one or all examples, the pitch used to form the pitch fibers can be an isotropic pitch. In one or all examples, the method can further include forming the pitch as an isotropic pitch from coal using a low severity direct coal liquefaction process.

In one or all examples, the stabilized pitch fibers can be carbonized at a temperature in a range from 1250° C. to 1350° C. in nitrogen. In one or all examples, the carbon fibers can be activated at a first temperature in a range from 825° C. to 875° C. for a first duration in a range of 5 hours to 7 hours followed by a second temperature in a range from 925° C. to 975° C. for a duration in a range of 1 hour to 2 hours in carbon dioxide. In one or all examples, the stabilized pitch fibers can be carbonized and the carbon fibers can be activated in a continuous process in carbon dioxide. In one or all examples, the stabilized pitch fibers can be carbonized and activated in a single step using potassium hydroxide at 700° C.

In one or all examples, the method can further include absorbing a selected gas with the activated carbon fibers and desorbing the selected gas from the activated carbon fibers by applying current to the activated carbon fibers. In one or all examples, a weight loss of the activated carbon fibers relative to the stabilized pitch fibers after the carbonizing and the activating can be at least 60%. In one or all examples, a weight loss of the activated carbon fibers relative to the stabilized pitch fibers after the carbonizing and the activating can be at least 70%.

Another aspect of the present disclosure relates to a filtration or gas adsorption material including activated carbon fibers having diameters of 20 μm or less and a specific area of at least 1900 m²/g.

In one or all examples, the activated carbon fibers can have an electrical resistivity in a range from 1 ohm-m to 1.3 ohm-m. In one or all examples, the activated carbon fibers can include large pores with diameters in a range from 200 nm to 400 nm surrounded by small pores with diameters of 100 nm or less. In one or all examples, the activated carbon fibers can include large pores with diameters in a range from 300 nm to 800 nm surrounded by small pores with diameters of 100 nm or less. In one or all examples, the activated carbon fibers can include pores with diameters of 2 microns and less.

Yet another aspect of the present disclosure relates to a method of producing an activated carbon fiber material. The method includes forming pitch fibers and simultaneously carbonizing and activating the pitch fibers into activated carbon fibers in an environment including carbon dioxide (CO₂) and water (H₂O).

In one or all examples, activating the pitch fibers can form the activated carbon fibers with a specific surface area of at least 1900 m²/g. In one or all examples, the method can further include using the activated carbon fibers to adsorb a selected gas and desorbing the selected gas from the activated carbon fibers by applying current to the activated carbon fibers. In one or all examples, forming the pitch fibers can include melt blowing pitch into fibers with diameters in a range from 1 μm to 20 μm.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a schematic view of a tube furnace.

FIGS. 2A, 2B, 2C, and 2D illustrate SEM images of melt blown fibers.

FIGS. 3A, 3B, and 3C illustrate SEM images of stabilized melt blown pitch fiber mats.

FIGS. 3D, 3E, and 3F illustrate SEM images of carbonized melt blown pitch fiber mats.

FIG. 4 illustrates a graph of weight loss versus temperature resulting from different thermal programs during activation of a carbon fiber mat.

FIGS. 5A, 5B, 5C, 5D, 5E, 5F, 5G, 5H, 5I, and 5J illustrate SEM images of activated pitch carbon fibers activated according to the thermal programs illustrated in FIG. 4.

FIGS. 6A and 6B illustrate SEM images of activated pitch carbon fibers.

FIG. 7 illustrates a graph of weight loss versus temperature resulting from different thermal programs during activation of a carbon fiber mat.

FIGS. 8A, 8B, 8C, and 8D illustrate SEM images of activated pitch carbon fibers activated according to the thermal programs illustrated in FIG. 4.

FIG. 9 illustrates a graph of weight loss versus temperature resulting from different thermal programs during carbonization and activation of a stabilized pitch fiber mat.

FIG. 10 illustrates a graph of weight loss versus temperature resulting from different thermal programs during activation of a stabilized fiber mat.

FIG. 11 illustrates a graph of weight loss versus temperature resulting from different thermal programs during activation of a stabilized fiber mat.

FIGS. 12A and 12B illustrate SEM images of activated pitch carbon fibers activated according to the thermal programs illustrated in FIG. 11.

FIG. 13 illustrates a schematic view of an activated carbon fiber mat connected to a direct current supply.

FIG. 14 illustrates a schematic view of heat generated in the activated carbon fiber mat of FIG. 13 connected to a direct current supply.

FIGS. 15A, 15B, 15C, 15D, 15E, and 15F illustrate isotherm plots from BET analyses of activated carbon fiber monolith samples.

FIGS. 16A, 16C, 16E, 16G, 16I, and 16K illustrate isostere plots from analyses of the activated carbon fiber monolith samples of FIGS. 15A through 15F, respectively.

FIGS. 16B, 16D, 16F, 16H, 16J, and 16L illustrate heat of adsorption plots from analyses of the activated carbon fiber monolith samples of FIGS. 15A through 15F, respectively.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are related to assemblies, systems, and methods for production of coal-based carbon fiber. The assemblies, systems, and methods of producing carbon fiber include a system for producing an isotropic pitch. In some examples, the oxygen content in coal can produce a pitch that more readily stabilizes. Therefore, lower melting point pitches can be used, making melt spinning or melt blowing processing potentially easier. The shorter stabilization process can render the pitch more economical as compared to using petroleum-based pitches, those made from coke oven pyrolysis tars (coal tar), or some made from other types of coals. The material is attractive for high temperature insulation and/or functional fibers such as activated carbon fibers that can be used in air or water purification applications. The activated carbon fibers can also be used in various chemical capture applications, including in the capture of rare earth elements (REEs).

In some examples, a specific surface area of activated carbon fibers can be measured by nitrogen adsorption and Brunauer-Emmett-Teller (BET) analysis. This can use a Micromeritics TriStar II surface area analyzer. The samples can be degassed for 12-14 hours at 350° C. in primary vacuum prior to testing.

In some examples, overall carbon yield obtained with Powder River Basin (PRB) fibers can be about 66%. This is high compared to other carbon fiber precursors. For example, polyacrylonitrile (PAN) typically provides a carbon yield of about 50%. The economical aspect of carbon fiber manufacturing and the manufacturing of carbon fiber mats can favor the precursors of the present disclosure due to the improved yield. The materials of the present disclosure can be suitable for the production of individual filaments, carbon fiber mats, and carbon fiber monoliths. These products, including carbon fiber mats and carbon fiber monoliths, can allow the materials to be used for additional industrial applications. This can include thermal insulation, filtration, gas adsorption, chemical capture (e.g., rare earth element (REE) capture, and the like.

A multi-filament extruder can be used to produce fibers with small diameters, such as about 20 μm or less. However, in some examples, the PRB coal pitch can be difficult to process using such extrusion due to the low softening point of the PRB coal pitch. For example, bridging in an extruder barrel can be difficult to avoid. The specific behavior of the PRB coal pitch fibers during stabilization (e.g., including fusion at the points of contacts) can favor the manufacture of a carbon bounded carbon fiber material from the PRB coal pitch. This can be advantageous as compared to traditional processes involving binders that are turned into carbon during a second carbonization step. In some examples, carbon fiber monoliths can be made from PRB coal pitch fibers in a single carbonization step. This can be used to reduce production costs and complexity.

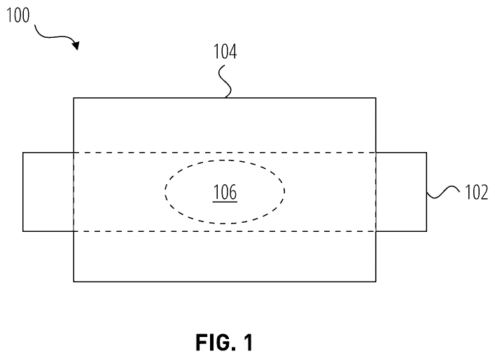

These and other examples are discussed below with reference to FIGS. 1 through 16L. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a schematic view of a tube furnace 100 that can be used in the production of carbon fiber mats formed from coal-based pitch. In some examples, the tube furnace 100 can be used to stabilize, carbonize, and/or activate pitch fibers that can be included in carbon fiber mats. The tube furnace 100 can include a tube 102 and a heater 104. Pitch fibers 106 can be positioned in the tube 102, the heater 104 can heat the tube 102 (and the pitch fibers 106 through the tube 102), and gases can be flowed over the pitch fibers 106 to stabilize, carbonize, and/or activate the pitch fibers 106. The pitch fibers 106 can be produced with diameters in a range from about 1 μm to about 20 μm. The tube furnace 100 of FIG. 1 can be used in the production of PRB coal melt blown pitch fibers, such as by being utilized to stabilize, carbonize, and/or activate the pitch fibers 106. In some examples, the tube furnace 100 can be a 100 mm tube furnace. However, any suitable tube furnace can be used.

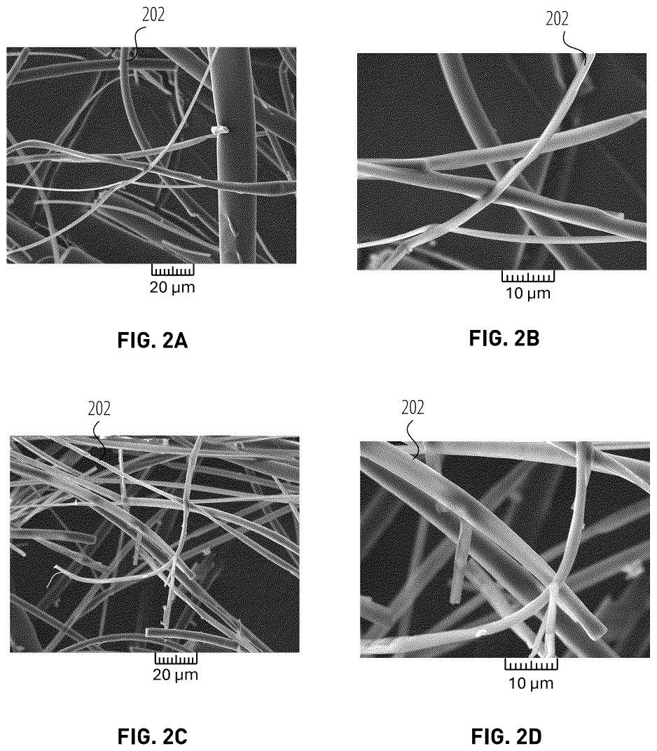

FIGS. 2A through 2D illustrate SEM images of melt blown pitch fibers 202. The melt blown pitch fibers 202 can be formed from coal (e.g., the fibers are coal-based) obtained from the Powder River Basin (PRB). As illustrated in FIGS. 2A through 2D, the pitch fibers 202 can have diameters in a range from about 1 μm to about 20 μm. The pitch fibers 202 can have relatively smooth surfaces. The pitch fibers 202 can be used for the pitch fibers 106, discussed above in reference to FIG. 1. The pitch fibers 202 can be used as precursors and various processes can be performed on the pitch fibers 202 to activate the pitch fibers 202.

The melt blown pitch fibers 202 illustrated in FIGS. 2A through 2D can be further processed to be used for various applications, including selected gas adsorption, liquid filtration, any processes used to capture rare earth elements (REEs), other elemental or chemical capture, or the like. To be used for such purposes, it can be beneficial to activate the surfaces of the melt blown pitch fibers 202 to generate increased microporosity and surface area. Stabilization, carbonization, and activation methods were investigated to increase the microporosity and surface area of the melt blown pitch fibers 202. The activated melt blown pitch fibers 202 can then be used to form carbon fiber mats, which can be used in the adsorption, filtration, and elemental or chemical capture applications.

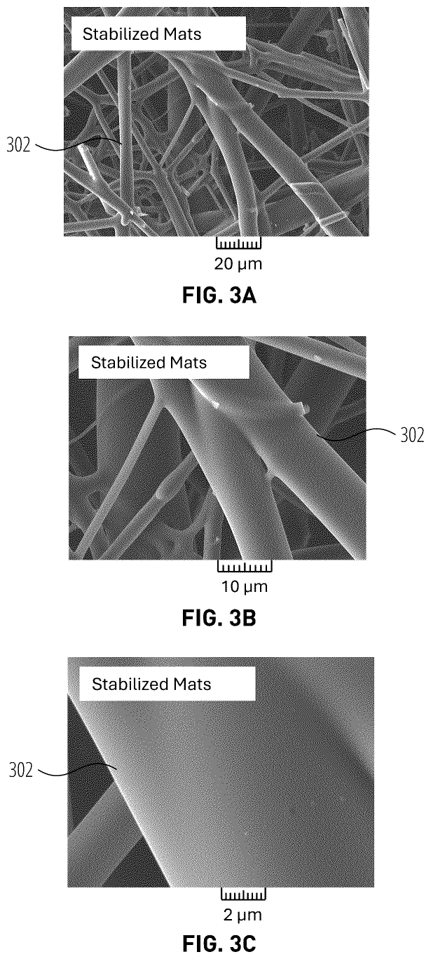

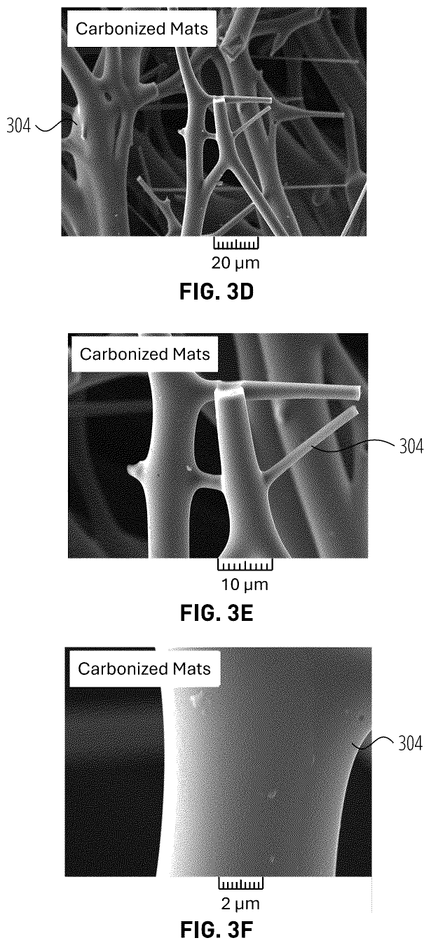

FIGS. 3A through 3F illustrate SEM images of melt blown pitch fiber mats. FIGS. 3A through 3C illustrate stabilized melt blown pitch fiber mats. FIGS. 3D through 3F illustrate carbonized melt blown pitch fiber mats. The pitch fiber mats can be produced by melt blowing pitch fibers.

In some examples, a tube furnace can be used to activate pitch fibers, such as PRB coal-based pitch fibers. The tube furnace and pitch fiber precursors can be the same as or similar to the tube furnace 100 and the pitch fiber 106, respectively, discussed above in reference to FIG. 1. The pitch fiber precursors can be the same as or similar to the pitch fibers 202 illustrated and discussed above in reference to FIGS. 2A through 2D. A method of activating the pitch fibers in the tube furnace can use carbon dioxide (CO₂) with added moisture. The moisture can be added through bubbling in a water tank. Heating the pitch fibers in the presence of carbon dioxide in the tube furnace can stabilize the pitch fibers, producing the stabilized pitch fibers 302 illustrated in FIGS. 3A through 3C.

The stabilized pitch fibers 302 (e.g., in the form of stabilized pitch fiber mats) can be carbonized. The stabilized pitch fibers 302 can be carbonized at a temperature of about 1300° C. (e.g., in a range from about 1250° C. to about 1350° C., in a range from about 1200° C. to about 1400° C., at a temperature of about 1200° C. or greater, at a temperature of about 1250° C. or greater, at a temperature of about 1300° C. or greater, at a temperature of about 1350° C. or greater, or the like). The stabilized pitch fibers 302 can be carbonized in a nitrogen (N₂) atmosphere using the tube furnace. In some examples, the pitch fibers can be stabilized and carbonized in the same or different tube furnaces. Using the same activation conditions with two different samples, values of the specific surface area of carbonized pitch fibers 304 (e.g., in the form of carbonized pitch fiber mats) of about 2000 m²/g can be obtained. In some examples, the carbonized pitch fibers 304 can have specific surface areas of about 1750 m²/g or greater, about 1500 m²/g or greater, about 1800 m²/g or greater, about 1900 m²/g or greater, about 2000 m²/g or greater, or the like. This demonstrates that this activation method (including stabilization and carbonization steps) can achieve a high specific surface area through activation of carbon fiber mats made from PRB coal.

An activation method can include exposure to carbon dioxide at high temperatures. In some examples, the porosity structure of activated carbon fiber materials (including the carbonized pitch fibers 304) can depend on the pitch precursor composition and the thermal program used during the activation. Values of weight loss up to 70% can be used to obtain values of specific surface areas close to 2000 m²/g, as measured by nitrogen adsorption and BET analysis. This weight loss can be determined based on weight loss measured between melt blown pitch fibers prior to activation and activated pitch fibers (e.g., the carbonized pitch fibers 304) following the activation (e.g., following stabilization and carbonization). Weight loss values of greater than about 40%, greater than about 50%, greater than about 60%, greater than about 65%, greater than about 70%, greater than about 75%, or the like can be beneficial for various applications, including adsorption, filtration, and elemental or chemical capture applications. Another factor in the suitability for activated carbon fibers and activated carbon fiber mats in various applications is the distribution of fiber diameters in the activated carbon fibers and activated carbon fiber mats. As higher values of weight loss are achieved, small fibers (e.g., fibers with smaller diameters, such as diameters at a low end of the fiber diameter range) can be completely burnt off before large porosity values are generated in large fibers (e.g., fibers with larger diameters, such as diameters at a high end of the fiber diameter range). This can be illustrated by the carbonized pitch fibers 304 having lower concentration of small-diameter fibers relative to the stabilized pitch fibers 302. Different thermal programs can be used to maintain or eliminate small diameter fibers in activated carbon fibers or activated carbon fiber mats.

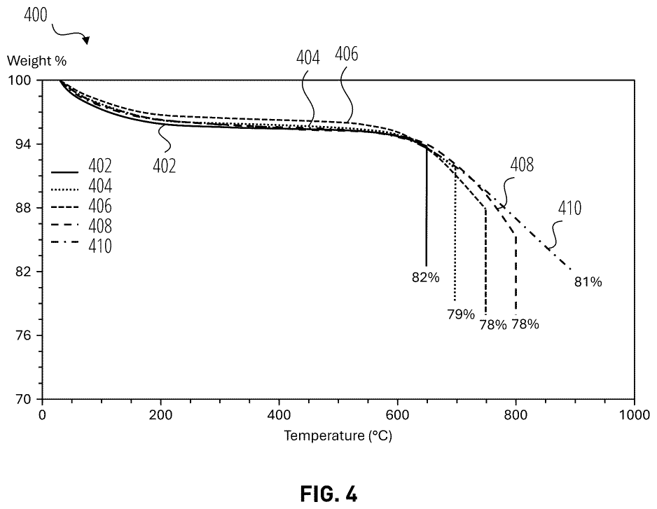

FIG. 4 illustrates a graph 400 of weight loss versus temperature resulting from different thermal programs during an activation of a carbon fiber mat. Each of the thermal programs can result in a weight loss of about 20% during the activation of the carbon fiber mat. The weight loss can be measured using thermogravimetric analysis (TGA). Each thermal program can be conducted in an atmosphere of carbon dioxide (CO₂).

FIG. 4 illustrates several thermal programs involving isotherms at different temperatures ranging from 650° C. to 900° C. Each of the thermal programs led to a weight loss of about 20%. For each of the thermal programs to reach equivalent weight losses, longer times were used for lower temperature isotherms and shorter times were used for higher temperature isotherms.

Line 402 illustrates percentage weight loss versus temperature for a carbon fiber mat that was heated by a first thermal program to 650° C. at a rate of 10° C./min and was maintained at a 650° C. isotherm for 40 minutes. This produced an activated carbon fiber mat with a weight of about 82% of the weight of the pre-activation carbon fiber mat or a weight loss of about 18%. Line 404 illustrates percentage weight loss versus temperature for a carbon fiber mat that was heated by a second thermal program to 700° C. at a rate of 10° C./min and was maintained at a 700° C. isotherm for 30 minutes. This produced an activated carbon fiber mat with a weight of about 79% of the weight of the pre-activation carbon fiber mat or a weight loss of about 21%. Line 406 illustrates percentage weight loss versus temperature for a carbon fiber mat that was heated by a third thermal program to 750° C. at a rate of 10° C./min and was maintained at a 750° C. isotherm for 20 minutes. This produced an activated carbon fiber mat with a weight of about 78% of the weight of the pre-activation carbon fiber mat or a weight loss of about 22%. Line 408 illustrates percentage weight loss versus temperature for a carbon fiber mat that was heated by a fourth thermal program to 800° C. at a rate of 10° C./min and was maintained at an 800° C. isotherm for 10 minutes. This produced an activated carbon fiber mat with a weight of about 78% of the weight of the pre-activation carbon fiber mat or a weight loss of about 22%. Line 410 illustrates percentage weight loss versus temperature for a carbon fiber mat that was heated by a fifth thermal program to 900° C. at a rate of 10° C./min and not maintained at an isotherm. This produced an activated carbon fiber mat with a weight of about 81% of the weight of the pre-activation carbon fiber mat or a weight loss of about 19%.

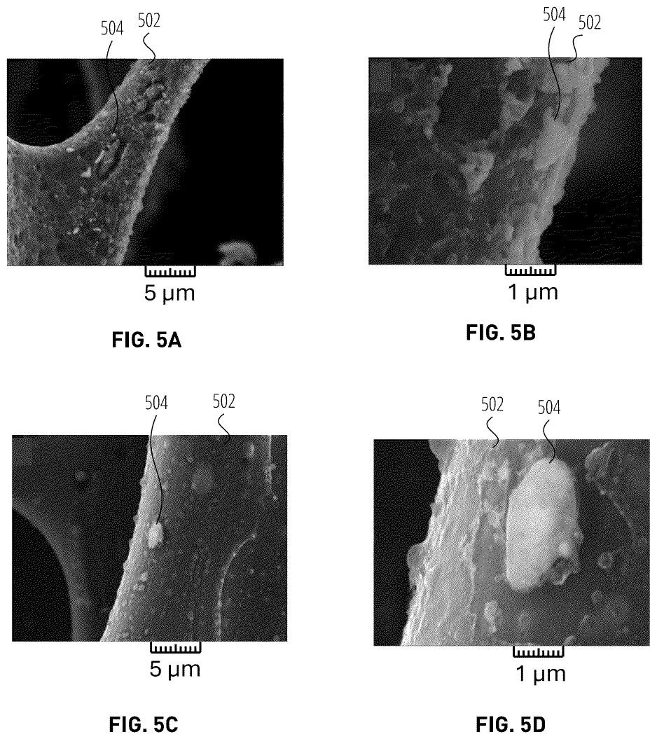

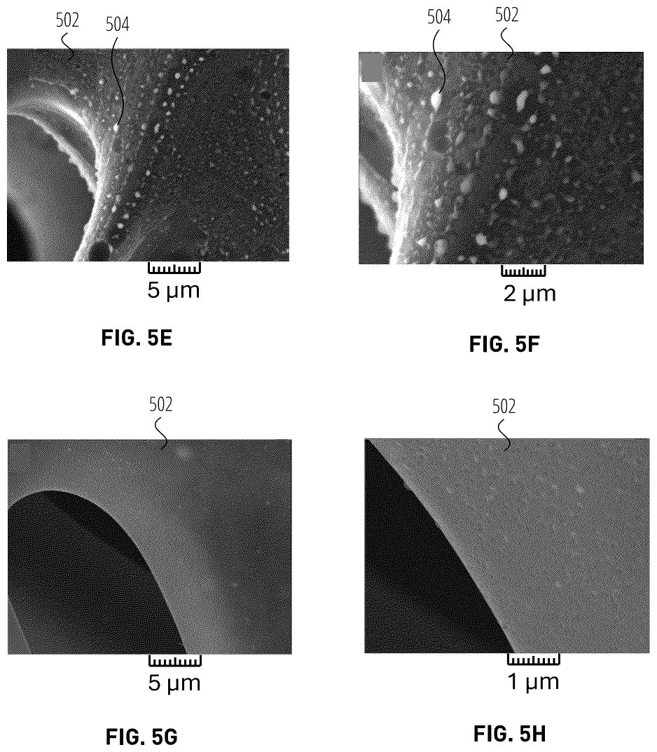

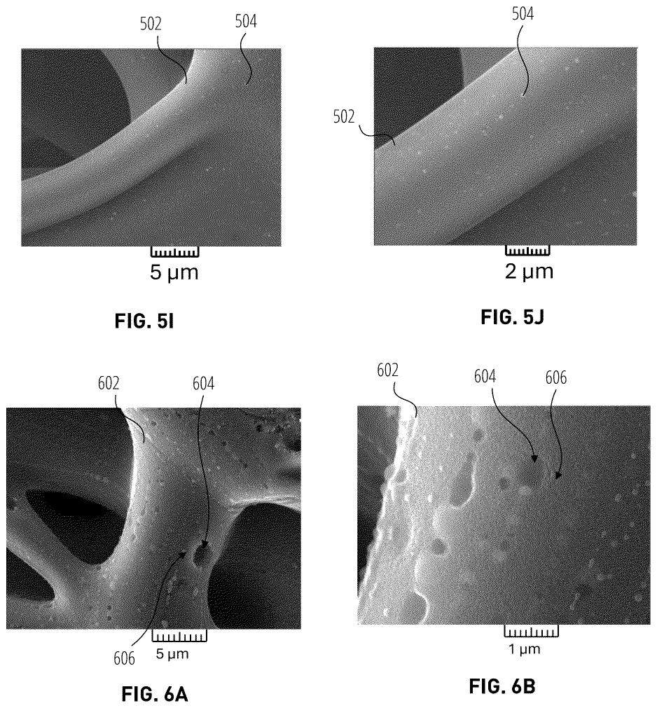

FIGS. 5A through 5J illustrate SEM images of activated pitch carbon fibers 502 activated according to the thermal programs illustrated in FIG. 4. FIGS. 5A and 5B illustrate the first thermal program, illustrated by line 402 in FIG. 4. FIGS. 5C and 5D illustrate the second thermal program, illustrated by line 404 in FIG. 4. FIGS. 5E and 5F illustrate the third thermal program, illustrated by line 406 in FIG. 4. FIGS. 5G and 5H illustrate the fourth thermal program, illustrated by line 408 in FIG. 4. FIGS. 51 and 5J illustrate the fifth thermal program, illustrated by line 410 in FIG. 4. The SEM images of the surfaces of the activated carbon fiber mats show a more severe etching as the temperature of the isotherm decreases. This may be due to additional time of reaction during the isotherm when the temperature of that isotherm is lower.

With more etching, round-shaped particles 504 made of heavier elements than carbon (appearing brighter as compared to the carbon fibers) and with sizes ranging from about 200 nm to about 1 μm can migrate to the surfaces of the activated pitch carbon fibers 502. An Energy Dispersive X-ray spectroscopy analysis carried out on an activated pitch carbon fiber 502 sample that was activated with the tube furnace revealed that the primary constituent of the particles 504 was silicon. The particles 504 further included traces of sulfur, magnesium, potassium, and chlorine. This suggests that the particles 504 are made of ash and are embedded in the activated pitch carbon fibers 502.

FIGS. 6A and 6B illustrate SEM images of activated pitch carbon fibers 602. The activated pitch carbon fibers 602 illustrated in FIGS. 6A and 6B were activated by a thermal program similar to the fourth thermal program, except that the isotherm was maintained for 15 minutes, rather than 10 minutes. This can produce a weight loss of about 29%. The activated pitch carbon fibers 602 were activated by carbon dioxide. With this temperature program, severe etching of the surfaces of the carbon fibers can be observed. This can produce large pores 604 having pore diameters ranging from about 300 nm to about 800 nm surrounded by small pores 606 having pore diameters equal to or less than about 100 nm. The specific surface area of the activated carbon fiber mats (including the activated pitch carbon fibers 602) measured by nitrogen adsorption and BET analysis was about 172 m²/g. This thermal program etched the surfaces of the carbon fibers, but did not generate micropores that led to high values of the specific surface area.

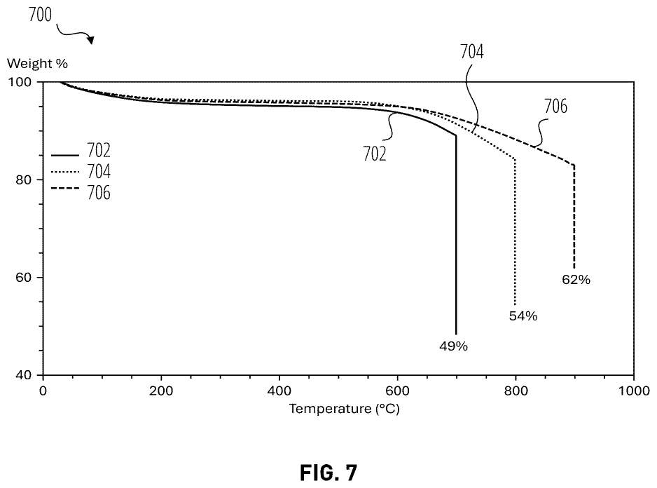

FIG. 7 illustrates a graph 700 of weight loss versus temperature resulting from different thermal programs during an activation of a carbon fiber mat. Each of the thermal programs can result in a weight loss in a range from about 40% to about 50% (or from about 35% to about 55%) during the activation of the carbon fiber mat. The weight loss can be measured using thermogravimetric analysis (TGA). Each thermal program can be conducted in an atmosphere of carbon dioxide (CO₂). FIG. 7 illustrates several thermal programs involving isotherms at different temperatures ranging from 700° C. to 900° C.

Line 702 illustrates percentage weight loss versus temperature for a carbon fiber mat that was heated by a first thermal program to 700° C. at a rate of 10° C./min and was maintained at a 700° C. isotherm for 2 hours. This produced an activated carbon fiber mat with a weight of about 49% of the weight of the pre-activation carbon fiber mat or a weight loss of about 51%. Line 704 illustrates percentage weight loss versus temperature for a carbon fiber mat that was heated by a second thermal program to 800° C. at a rate of 10° C./min and was maintained at an 800° C. isotherm for 70 minutes. This produced an activated carbon fiber mat with a weight of about 54% of the weight of the pre-activation carbon fiber mat or a weight loss of about 46%. Line 706 illustrates percentage weight loss versus temperature for a carbon fiber mat that was heated by a third thermal program to 900° C. at a rate of 10° C./min and was maintained at a 900° C. isotherm for 1 hour. This produced an activated carbon fiber mat with a weight of about 62% of the weight of the pre-activation carbon fiber mat or a weight loss of about 38%.

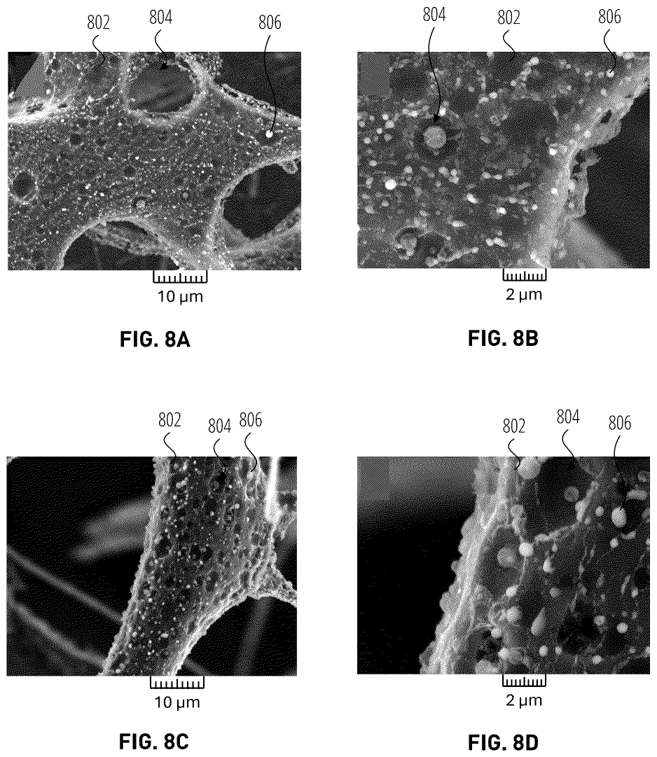

FIGS. 8A through 8D illustrate SEM images of activated pitch carbon fibers 802 activated according to the thermal programs illustrated in FIG. 7. FIGS. 8A and 8B illustrate the first thermal program, illustrated by line 702 in FIG. 7. FIGS. 8C and 8D illustrate the second thermal program, illustrated by line 704 in FIG. 7.

Increasing weight loss resulting from the thermal programs illustrated in the graph 700 led to increased densities of large pores 804 having pore diameters of up to about 2 μm. The large pores 804 can have diameters in a range from about 300 nm to about 2.5 μm, in a range from about 500 nm to about 2 μm, greater than about 500 nm, greater than about 1 μm, greater than about 1.5 μm, or the like. The increased weight loss further led to a higher surface density of particles 806 (e.g., mineral particles). The particles 806 can be the same as or similar to the particles 504 that include silicon as the primary constituent, discussed above with respect to FIGS. 5A through 5J.

In each of the examples discussed in reference to FIGS. 4 through 8D, the carbon fibers were activated using carbon dioxide activation in a TGA instrument. The same carbon fibers can be activated in a tube furnace containing a pure carbon dioxide environment, which can be the same as or similar to the tube furnace 100 discussed above in reference to FIG. 1. For example, Table 1, below, illustrates an analysis of carbon fibers activated in a 100 mm tube furnace in a carbon dioxide environment at 900° C. for 1 hour. Table 1 provides the weight loss and associated specific surface area for such an activation.

TABLE 1
CO₂ activation of PRB coal melt blown carbon fiber mat

| | | Weight | Specific |
|---|---|---|---|
| CO₂ activation | Time | loss | surface area |
| at 900° C. | (hr) | (%) | (m²/g) |
| Fibers carbonized | 1 | 28 | 337 |
| at 1300° C. | | | |

A direct comparison between a CO₂ activation of carbon fibers in a TGA instrument or in a tube furnace is challenging due to different CO₂ flow rates and associated pressures. Generally, activations based on the same time durations led to a higher weight loss in the TGA instrument relative to the tube furnace. This is illustrated by FIG. 7, which illustrates a weight loss of about 38% for the third thermal program illustrated by line 706. These early results suggest that there is some potential to reach high values of specific surface area with an activation in CO₂. Using the same tube furnace, another method of activation can involve adding moisture to the incoming CO₂ through bubbling in a water tank. Table 2 provides the activation conditions and associated specific surface area for such an activation.

TABLE 2
CO₂ activation of PRB coal melt blown carbon fiber mat

| | | Specific |
|---|---|---|
| Activation using CO₂ | | surface |
| and H₂O | Thermal program | area (m²/g |
| Fibers carbonized at | 6 hours at 850° C. followed by 1.5 | 2,237 |
| 1300° C. | hours at 950° C. | |
| Fibers carbonized at | 6 hours at 850° C. followed by 1.5 | 1,957 |
| 1300° C. | hours at 950° C. | |

Using the same activation conditions with two different samples, values around 2000 m²/g were obtained. This demonstrates that high values of the specific area can be achieved by activation of carbon fiber mats made from PRB coal.

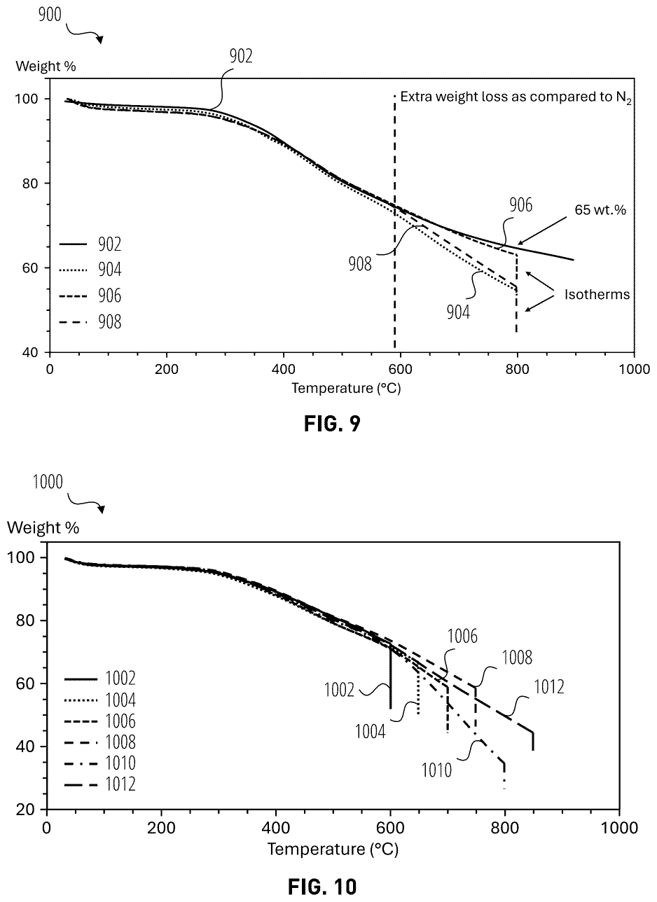

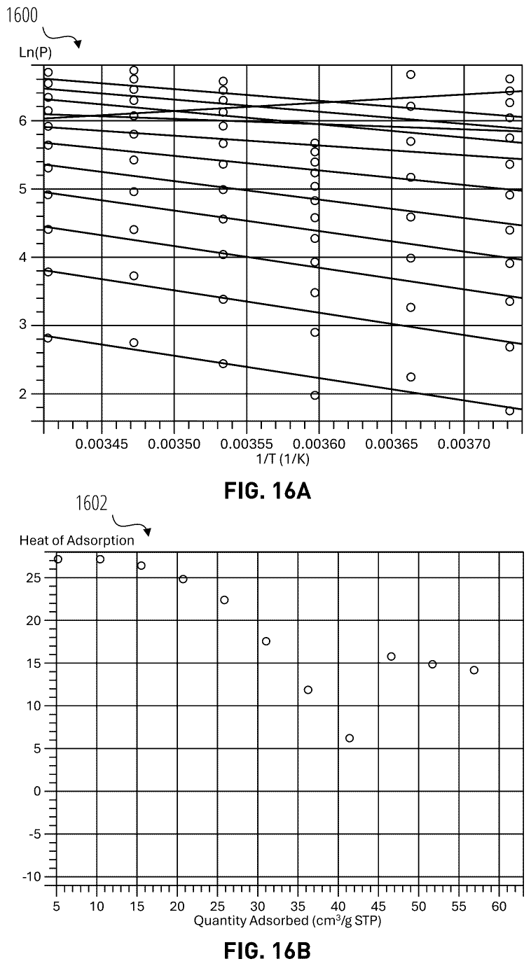

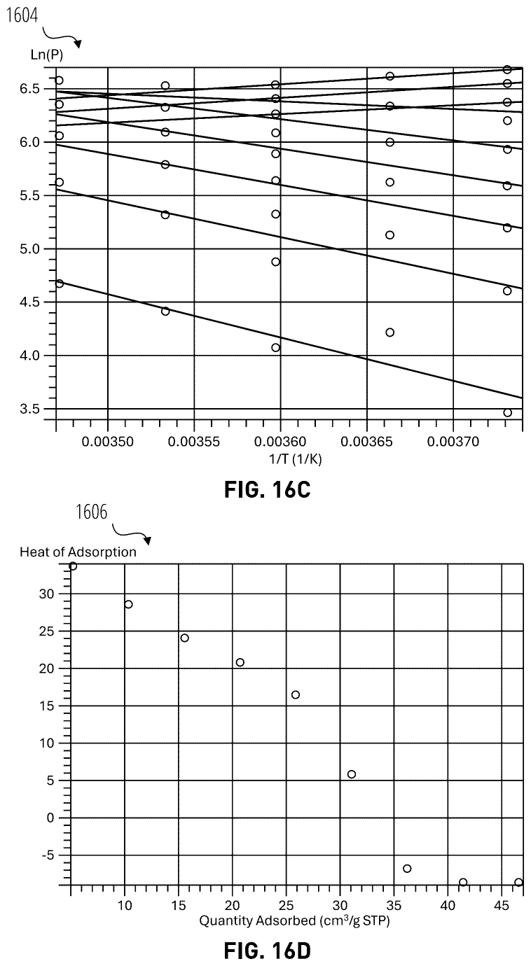

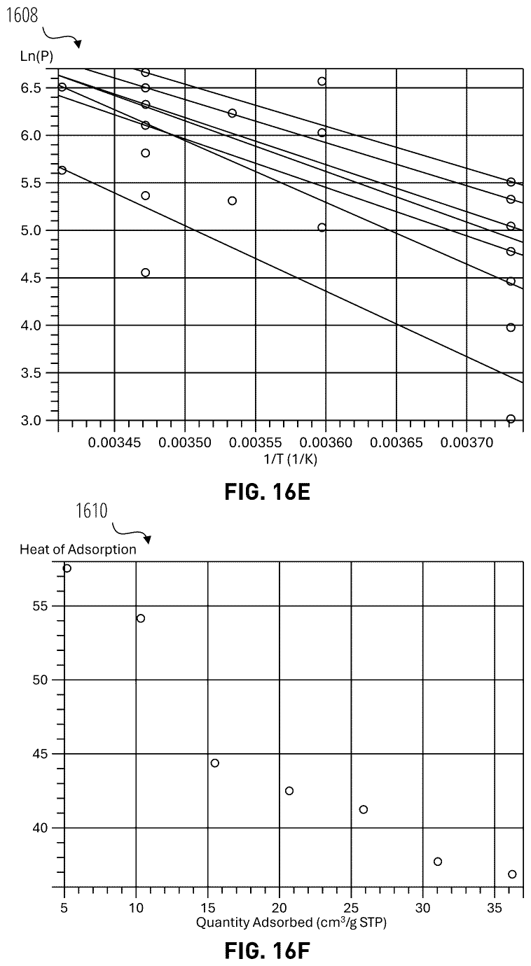

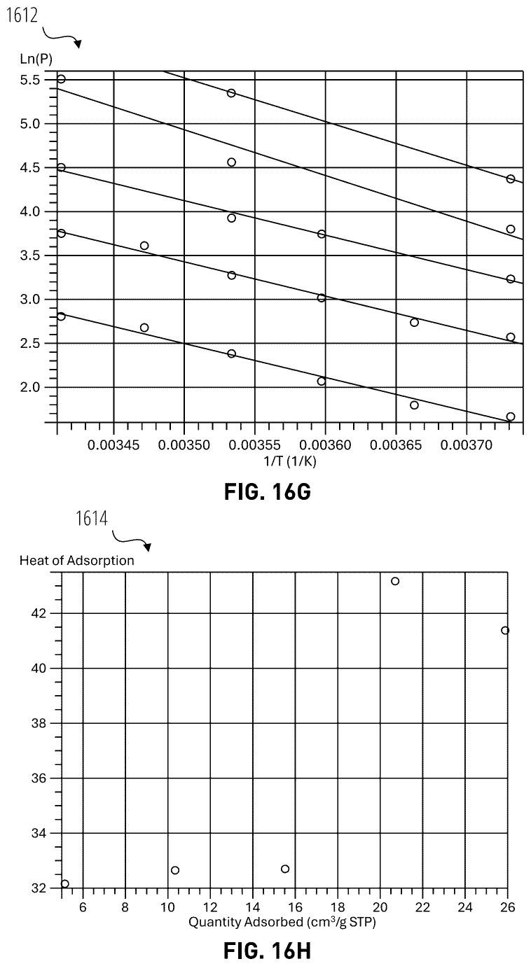

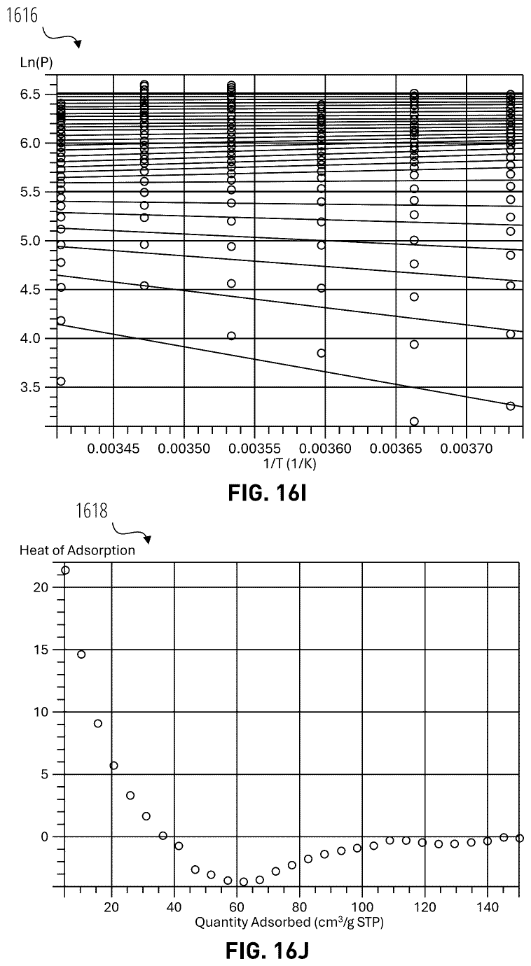

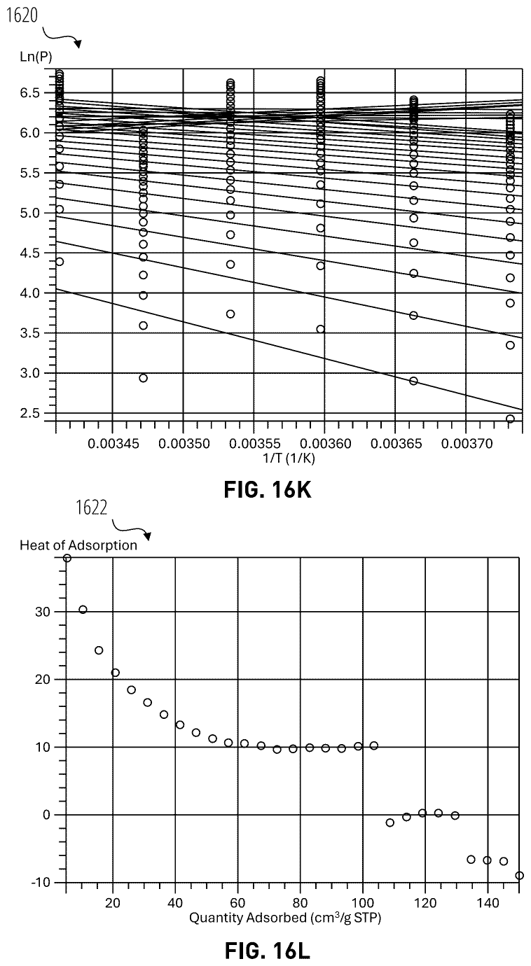

FIG. 9 illustrates a graph 900 of weight loss versus temperature resulting from different thermal programs during carbonization and activation of a stabilized pitch fiber mat. FIG. 9 illustrates a third activation method that can include a simultaneous carbonization and activation of pitch fibers in a carbon dioxide atmosphere. This third activation method can include a low temperature carbonization and an activation using potassium hydroxide. The carbonization and activation can be performed in a single step at a temperature of 700° C. TGA measurements were performed following the same ramp in atmospheres or environments of nitrogen and carbon dioxide. The TGA measurements indicate that the weight loss of a stabilized pitch fiber mat follows the same profile up to 600° C. (illustrated in FIG. 16). This suggests that no activation mechanism occurs in this range of temperature and that the reactions that occur are regular carbonization-related reactions (as seen in the nitrogen atmosphere). In other words, the same reactions occur in both the nitrogen atmosphere and the carbon dioxide atmosphere. Between 600° C. and 800° C., extra weight loss can be observed with the carbon dioxide (CO₂) atmosphere. This suggests that activation reactions are taking place in this temperature range.

FIG. 9 illustrates several thermal programs. Line 902 illustrates percentage weight loss versus temperature for a carbon fiber mat that was heated by a first thermal program to 900° C. at a rate of 10° C./min in a nitrogen atmosphere (N₂). This produced a carbonized carbon fiber mat with a weight of about 65% of the weight of the pre-carbonization carbon fiber mat or a weight loss of about 35% (measured when a temperature of the carbonized carbon fiber mat was about 800° C.). Further temperature increase produced a carbonized carbon fiber mat with a weight of about 60-65% of the weight of the pre-carbonization carbon fiber mat or a weight loss of about 35-40%. Lines 904, 906, and 908 illustrate percentage weight loss versus temperature for three samples of carbon fiber mats that were heated by a second thermal program to 800° C. at a rate of 10° C./min in a carbon dioxide (CO₂) atmosphere and then maintained at an 800° C. isotherm for a period of time. The thermal program of the line 904 produced an activated carbon fiber mat with a weight of about 50-55% of the weight of the pre-activation carbon fiber mat or a weight loss of about 45-50%. The thermal program of the line 906 produced an activated carbon fiber mat with a weight of about 55-60% of the weight of the pre-activation carbon fiber mat or a weight loss of about 40-45%. The thermal program of the line 908 produced an activated carbon fiber mat with a weight of about 42-47% of the weight of the pre-activation carbon fiber mat or a weight loss of about 53-58%. The isotherm for the line 904 can have a relatively short duration or can be omitted. Each of the thermal programs illustrated by the lines 902, 904, 906, 908 can be used to produce stabilized pitch fibers or a stabilized pitch fiber mat.

FIG. 10 illustrates a graph 1000 of weight loss versus temperature resulting from different thermal programs during activation of a stabilized pitch fiber mat. FIG. 10 illustrates a first round of TGA measurements that include various thermal programs carried out in carbon dioxide (CO₂) atmospheres. Activation through the thermal programs was carried out on stabilized pitch fiber mats to evaluate the kinetics of weight loss at different isotherm temperatures in a range from 600° C. to 850° C. with 50° C. increments. There was some heterogeneity in the structures of the stabilized pitch fiber mats, which included varying degrees of stabilization, fiber diameter distributions, and fiber volume concentrations. As a result, line 1010 showed a relatively faster degradation rate. Overall, weight loss values ranging from about 50% to about 60% were obtained through the various thermal programs.

FIG. 10 illustrates several thermal programs. Line 1002 illustrates percentage weight loss versus temperature for a carbon fiber mat that was heated by a first thermal program to 600° C. at a rate of 10° C./min and was maintained at a 600° C. isotherm for 30 minutes. This produced an activated carbon fiber mat with a weight of about 50-55% of the weight of the pre-activation carbon fiber mat or a weight loss of about 45-50%. Line 1004 illustrates percentage weight loss versus temperature for a carbon fiber mat that was heated by a second thermal program to 650° C. at a rate of 10° C./min and was maintained at a 650° C. isotherm for 30 minutes. This produced an activated carbon fiber mat with a weight of about 47-53% of the weight of the pre-activation carbon fiber mat or a weight loss of about 47-53%. Line 1006 illustrates percentage weight loss versus temperature for a carbon fiber mat that was heated by a third thermal program to 700° C. at a rate of 10° C./min and was maintained at a 700° C. isotherm for 15 minutes. This produced an activated carbon fiber mat with a weight of about 42-47% of the weight of the pre-activation carbon fiber mat or a weight loss of about 53-58%. Line 1008 illustrates percentage weight loss versus temperature for a carbon fiber mat that was heated by a fourth thermal program to 750° C. at a rate of 10° C./min and was maintained at a 750° C. isotherm for 15 minutes. This produced an activated carbon fiber mat with a weight of about 43-48% of the weight of the pre-activation carbon fiber mat or a weight loss of about 52-57%. Line 1010 illustrates percentage weight loss versus temperature for a carbon fiber mat that was heated by a fifth thermal program to 800° C. at a rate of 10° C./min and was maintained at a 800° C. isotherm for 5 minutes. This produced an activated carbon fiber mat with a weight of about 25-30% of the weight of the pre-activation carbon fiber mat or a weight loss of about 70-75%. Line 1012 illustrates percentage weight loss versus temperature for a carbon fiber mat that was heated by a sixth thermal program to 850° C. at a rate of 10° C./min and was maintained at a 850° C. isotherm for 5 minutes. This produced an activated carbon fiber mat with a weight of about 38-43% of the weight of the pre-activation carbon fiber mat or a weight loss of about 57-62%.

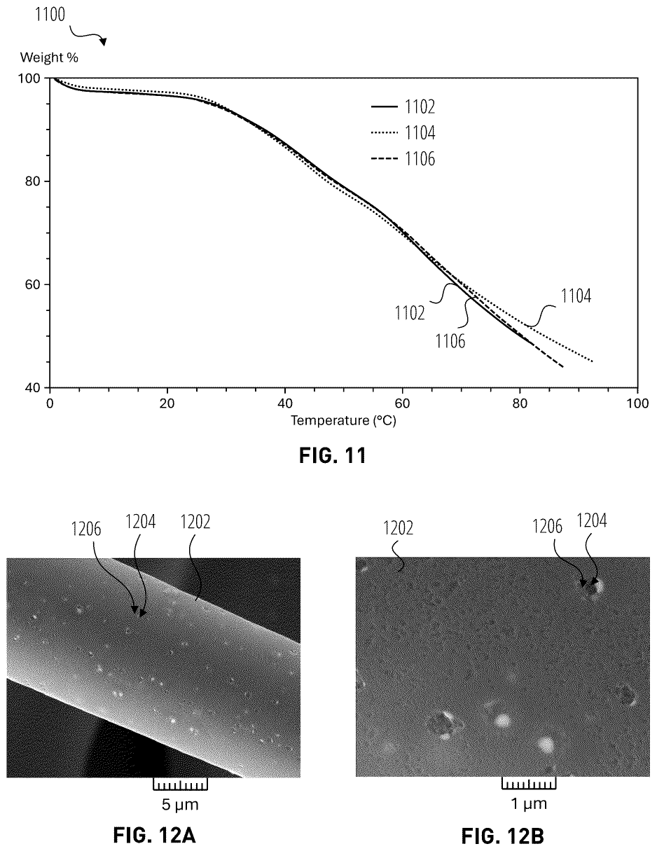

FIG. 11 illustrates a graph 1100 of weight loss versus temperature resulting from different thermal programs during activation of a stabilized pitch fiber mat. FIG. 11 illustrates a second round of TGA measurements that include various thermal programs carried out in carbon dioxide (CO₂) atmospheres. Measurement of the nitrogen adsorption of samples treated with isotherms at lower temperatures (e.g., up to about 750° C.) can be difficult due to the desorption of some of the pitch molecular compounds during the sample conditions (e.g., heating under a primary vacuum at 300° C.) and during analysis. The second round of TGA experiments focused on the isotherms at 800° C. and 850° C. Weight losses of about 65% (e.g., in a range from about 50% to about 65%) were obtained for both temperatures, as illustrated in the graph 1100. This corresponds to a weight loss of about 30% due to activation alone in the case of the isotherm at 800° C. (as compared to the same sample run in nitrogen, illustrated by line 902 in FIG. 9).

FIG. 11 illustrates several thermal programs. Line 1102 illustrates percentage weight loss versus temperature for a carbon fiber mat that was heated by a first thermal program to 800° C. at a rate of 10° C./min and was maintained at a 800° C. isotherm for 5 minutes. This produced an activated carbon fiber mat with a weight of about 45-50% of the weight of the pre-activation carbon fiber mat or a weight loss of about 50-55%. Line 1104 illustrates percentage weight loss versus temperature for a carbon fiber mat that was heated by a second thermal program to 800° C. at a rate of 10° C./min and was maintained at a 800° C. isotherm for 15 minutes. This produced an activated carbon fiber mat with a weight of about 42-48% of the weight of the pre-activation carbon fiber mat or a weight loss of about 52-58%. Line 1106 illustrates percentage weight loss versus temperature for a carbon fiber mat that was heated by a third thermal program to 850° C. at a rate of 10° C./min and was maintained at a 850° C. isotherm for 5 minutes. This produced an activated carbon fiber mat with a weight of about 42-47% of the weight of the pre-activation carbon fiber mat or a weight loss of about 53-58%.

FIGS. 12A and 12B illustrate SEM images of activated pitch carbon fibers 1202 activated according to the thermal programs illustrated in FIG. 11. FIG. 12A illustrates the third thermal program, illustrated by the line 1106 in FIG. 11. FIG. 12B illustrates the second thermal program, illustrated by the line 1104 in FIG. 11. SEM pictures corresponding to both samples of activated fibers with weight losses of about 65% (e.g., in a range from about 50-60%) showed a few large pores 1204 having diameters in a range from about 200 nm to about 400 nm surrounded by a high density of small pores 1206 having diameters smaller than about 100 nm.

By following the second thermal program illustrated by the line 1104 in FIG. 11, a specific surface area of about 446 m²/g can be obtained. This thermal program includes the sample being activated for 15 minutes at 800° C. This specific surface area is still low as compared to the high specific surface area values obtained with other activations of corresponding carbon fibers. The SEM pictures reveal that the etching of the surface was not severe and longer times of activation may increase the value of the specific surface area. In some examples, the kinetics of weight loss during an isotherm in CO₂ can be faster for a stabilized pitch fiber as compared to the corresponding carbon fiber. If high values of specific area were to be obtained with this process, significant cost and energy savings could be achieved as compared to the current process for making activated carbon fiber monoliths. In some examples, the different activation methods can obtain an activated carbon fiber mat with a high value of the specific surface area (around 2000 m²/g).

The high value of specific surface area obtained with activation in an atmosphere that includes a mixture of carbon dioxide (CO₂) and water (H₂O) can enable the use of the activated carbon fiber mat in various applications. For example, the activated carbon fiber mat can be used as an adsorbent for gas purification, especially for the capture of CO₂. The activated carbon fiber mat or activated carbon fiber monoliths can be used in the capture of rare earth elements (REE's) and the like.

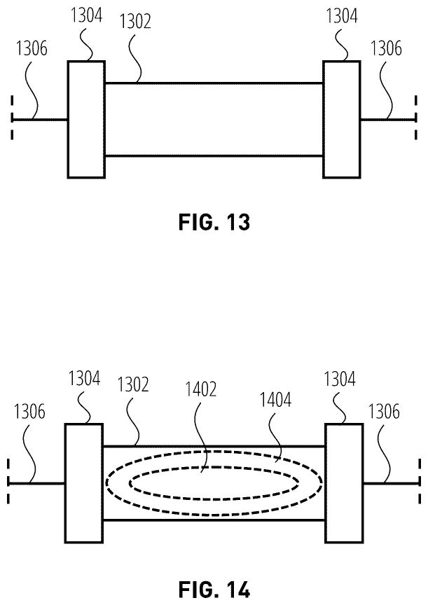

FIG. 13 illustrates a schematic view of an activated carbon fiber mat 1302 connected to a direct current supply. The activated carbon fiber mat 1302 can be connected to the direct current supply through electrodes 1304 connected to the direct current supply through clamps 1306. One of the energy consuming steps for utilizing activated carbon fiber mats application is the regeneration of the sorbent with no modification of its surface properties, so that cycles of adsorption and desorption can be run as many times as possible. Typically, heating the surface of an activated carbon material that is saturated with CO₂ to temperatures close to 100° C. will desorb the CO₂ and regenerate the surface. Other desorption processes can be used to release other captured chemicals or elements (e.g., rare earth elements and the like) from the surfaces of carbon fiber materials. Using the electrical resistance of the activated carbon fiber materials of the present disclosure (e.g., activated carbon fibers and activated carbon fiber mats) to reach desorption temperatures by Joule effect heating is an energy-efficient process. The possibility to use an electric swing adsorption for an eventual regeneration of the activated carbon fiber mat can be characterized using a direct current supply and mounting the activated carbon fiber mat 1302 between two metallic clamps 1306 acting as electrodes 1304 as shown in FIG. 13.

FIG. 14 illustrates a schematic view of heat generated in the activated carbon fiber mat 1302 of FIG. 13 connected to a direct current supply, as characterized by an infra-red camera. The electrical resistivity of the activated carbon fiber mat 1302 was about 1.1 ohm-m. By applying a voltage of 20 V through the clamps 1306 and the electrodes 1304, a surface temperature of more than 100° C. of the activated carbon fiber mat 1302 was obtained within a few seconds. A central region 1402 reached a temperature of about 108.8° C. while a surrounding region 1404 reached a temperature of greater than about 100° C. Based on this characterization, electrical swing adsorption can be used with the activated carbon fiber mat 1302 made with the isotropic pitch and PRB coal. The activated carbon fiber mat 1302 can be activated using any of the activation and thermal programs discussed herein.

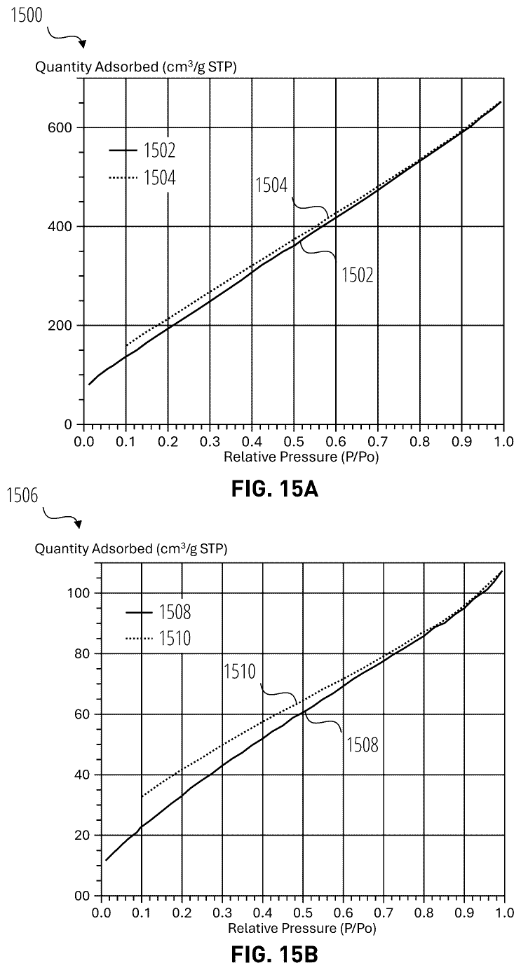

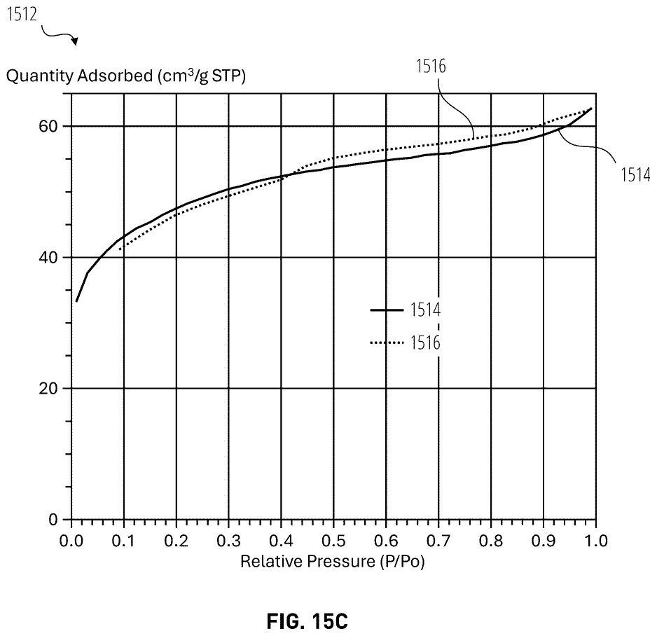

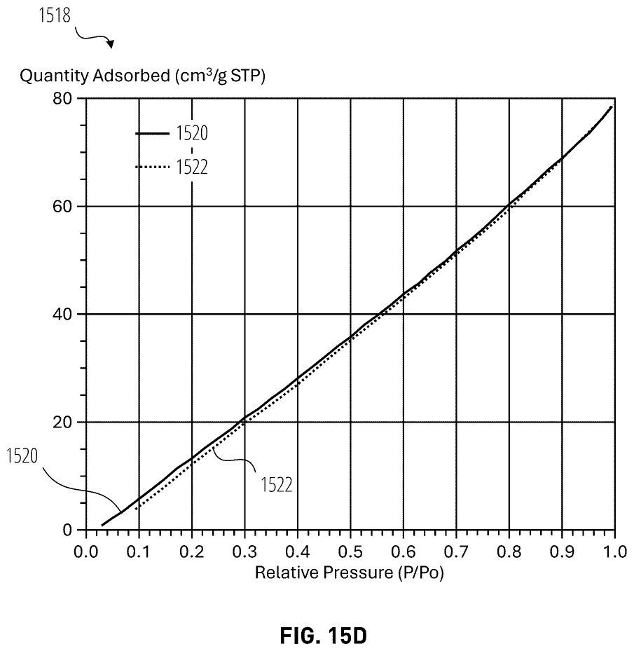

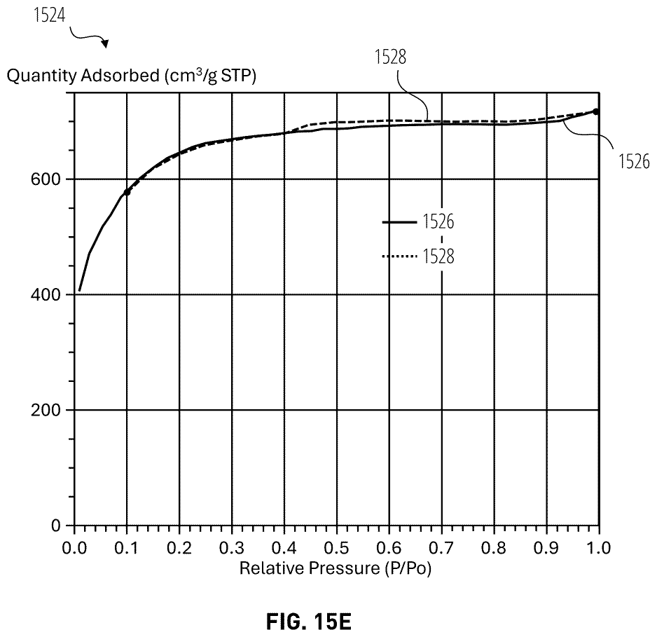

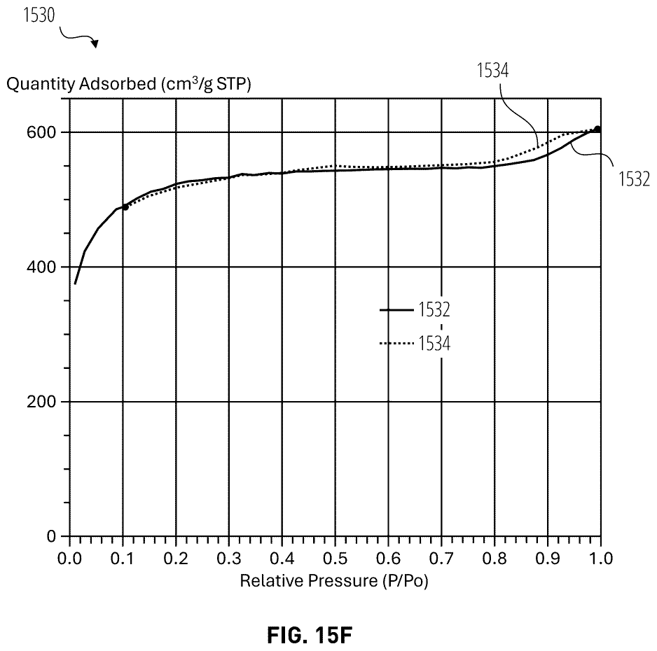

FIGS. 15A through 15F illustrate isotherm plots from nitrogen Brunauer, Emmett, and Teller (BET) analyses of activated carbon fiber monolith samples. The nitrogen BET surface can be determined using a Micromeritics Tristar II surface area analyzer. The results of several fiber monolith samples, including both the fibers that had been activated in the pitch fiber state and carbon fiber state are included. The isotherm plots are provided in FIGS. 15A through 15F to indicate the raw data obtained. Table 3, below, provides the surface area results determined by the standard BET analysis.

Each of FIGS. 15A through 15F illustrates a plot of quantity adsorbed in cm³/g STP on the y-axis versus relative pressure in P/P₀ on the x-axis. FIG. 15A illustrates a graph 1500 for a sample that is pitch fiber activated at a temperature of 800° C. Line 1502 illustrates adsorption and line 1504 illustrates desorption. The graph 1500 illustrated in FIG. 15A analyzes a sample activated to an activation and thermal program the same as or similar to those discussed above with respect to lines 1102 or 1104, discussed above with respect to FIG. 11. FIG. 15B illustrates a graph 1506 for a sample that is pitch fiber activated at a temperature of 850° C. Line 1508 illustrates adsorption and line 1510 illustrates desorption. The graph 1506 illustrated in FIG. 15B analyzes a sample activated to an activation and thermal program the same as or similar to those discussed above with respect to line 1106, discussed above with respect to FIG. 11. FIG. 15C illustrates a graph 1512 for a sample that is carbonized fiber activated at a temperature of 800° C. Line 1514 illustrates adsorption and line 1516 illustrates desorption. The graph 1512 illustrated in FIG. 15C analyzes a sample activated to an activation and thermal program the same as or similar to those discussed above with respect to lines 904, 906, or 908, discussed above with respect to FIG. 9. FIG. 15D illustrates a graph 1518 for a sample that is pitch fiber activated at a temperature of 900° C. with a 5 minutes isotherm at 900° C. Line 1520 illustrates adsorption and line 1522 illustrates desorption. The graph 1518 illustrated in FIG. 15D analyzes a sample activated according to an activation and thermal program the same as or similar to those discussed above with respect to Table 1. This can include carbonization at 1300° C. and activation in an atmosphere of carbon dioxide. FIG. 15E illustrates a graph 1524 for a sample that is carbonized fiber activated at a temperature of 850° C. for a duration of 6 hours followed by a temperature of 900° C. for a duration of 1.5 hours. Line 1526 illustrates adsorption and line 1528 illustrates desorption. FIG. 15F illustrates a graph 1530 for a sample that is carbonized fiber activated at a temperature of 850° C. for a duration of 6 hours followed by a temperature of 900° C. for a duration of 1.5 hours. Line 1532 illustrates adsorption and line 1534 illustrates desorption. The graphs 1524 and 1530 illustrated in FIGS. 15E and 15F analyze samples activated according to activation and thermal programs the same as or similar to those discussed above with respect to Table 2. This can include carbonization at 1300° C. and activation in an atmosphere of carbon dioxide and water.

TABLE 3
Specific surface area of activated carbon fiber monoliths
N₂ BET Results Summary

| | Specific |
|---|---|
| | Surface Area |
| Sample ID | (m²/g) |
| P800, graph 1500 | 446.05 |
| 850, graph 1506 | 80.39 |
| C800, graph 1512 | 169.62 |
| 1SA, graph 1518 | 3.84 |
| RA9, graph 1524 | 2,237.16 |
| RA10, graph 1530 | 1,957.06 |

FIGS. 16A through 16L illustrate isostere and heat of adsorption plots for each of the samples analyzed by the isotherm plots of FIGS. 15A through 15F. FIGS. 16A, 16C, 16E, 16G, 16I, and 16K illustrate isostere plots. The isostere plots illustrate plots of ln(P) on the y-axis versus the inverse of absolute temperature (1/T) on the x-axis. The units for pressure can be relative pressure in P/P₀. The units for temperature can be Kelvin (e.g., the x-axis illustrates 1/K). FIGS. 16B, 16D, 16F, 16H, 16J, and 16L illustrate heat of adsorption plots. The heat of adsorption plots illustrate plots of heat of adsorption in kJ/mol on the y-axis versus quantity adsorbed in cm³/g STP on the x-axis. FIGS. 16A and 16B illustrate a graph 1600 and a graph 1602, respectively, corresponding to the sample analyzed in FIG. 15A. FIGS. 16C and 16D illustrate a graph 1604 and a graph 1606, respectively, corresponding to the sample analyzed in FIG. 15B. FIGS. 16E and 16F illustrate a graph 1608 and a graph 1610, respectively, corresponding to the sample analyzed in FIG. 15C. FIGS. 16G and 16H illustrate a graph 1612 and a graph 1614, respectively, corresponding to the sample analyzed in FIG. 15D. FIGS. 161 and 16J illustrate a graph 1616 and a graph 1618, respectively, corresponding to the sample analyzed in FIG. 15E. FIGS. 16K and 16L illustrate a graph 1620 and a graph 1622, respectively, corresponding to the sample analyzed in FIG. 15F. CO₂ adsorption isotherms were obtained at −5° C., 0° C., 5° C., 10° C., 15° C., and 20° C. and instrument software was utilized to perform the heat of adsorption determination.

Many industrial applications could benefit from a cost-effective activated carbon fiber monolith and/or mat. The controlled capture and release of gases, including carbon dioxide and volatile organic compounds and the controlled capture and release of moisture from air for indoor air conditioning are two potential high volume applications. A carbon fiber mat enables the use of electric swing adsorption for the regeneration of the fiber surface. Energy storage applications are another sector representing high value. A few examples include hydrogen storage and the manufacture of supercapacitors for transportation (e.g., cars, buses, trains, and the like) and for cranes or elevators. For these applications, intermediate values of specific surface area for the activated carbon fiber mat (e.g., several hundred m²/g) are appropriate. In one or all examples, the activated carbon fiber monoliths and/or activated carbon fiber mats can be used to capture specific elements or compounds. For example, the activated carbon fiber monoliths and/or activated carbon fiber mats can be used to capture or separate rare earth elements from various product streams.

Using the low severity direct coal liquefaction process with PRB coal, an isotropic pitch can be produced. Processing of the isotropic pitch can include melt spinning and melt blowing the isotropic pitch to make carbon fiber mats. The subbituminous coal pitch can exhibit an interesting stabilization behavior, namely that it can be stabilized despite having a low value of the dropping point. Fusion at the point of contacts between the fibers can allow the creation of structures that resemble carbon fiber carbon-bonded materials. The generation of a high specific surface area of 2000 m²/g by activation in CO₂ and moisture can be obtained. The heating of the carbon fiber surface by Joule effect can be demonstrated, showing that electric swing adsorption can be considered for the regeneration of the carbon fiber mat.

This represents an opportunity to manufacture activated carbon fiber monoliths or activated and bounded carbon fiber mats with a simplified method that is cost and energy efficient as compared to the current technology. Several industrial applications including the capture of carbon dioxide or organic volatiles from air or exhaust gas can be targeted.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, or +2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

As used herein, conjunctive terms (e.g., “and”) and disjunctive terms (e.g., “or”) should be read as being interchangeable (e.g., “and/or”) whenever possible. Furthermore, in claims reciting a selection from a list of elements following the phrase “at least one of,” usage of “and” (e.g., “at least one of A and B”) requires at least one of each of the listed elements (i.e., at least one of A and at least one of B), and usage of “or” (e.g., “at least one of A or B”) requires at least one of any individual listed element (i.e., at least one of A or at least one of B). It is noted that, when described or recited herein, the use of the articles such as “a” or “an” is not considered to be limiting to only one, but instead is intended to mean one or more unless otherwise specifically noted herein.

What is claimed is:

1. A method of producing an activated carbon fiber material for filtration or gas adsorption, the method comprising:
melt blowing pitch to form pitch fibers;
stabilizing the pitch fibers to form stabilized pitch fibers;
carbonizing the stabilized pitch fibers to form carbon fibers; and
activating the carbon fibers to form activated carbon fibers with a specific surface area of at least 1900 m²/g.

2. The method of claim 1, wherein melt blowing the pitch forms the pitch fibers with diameters in a range from 1 μm to 20 μm.

3. The method of claim 1, wherein the pitch used to form the pitch fibers is an isotropic pitch.

4. The method of claim 1, further comprising forming the pitch as an isotropic pitch from coal using a low severity direct coal liquefaction process.

5. The method of claim 1, wherein the stabilized pitch fibers are carbonized at a temperature in a range from 1250° C. to 1350° C. in nitrogen.

6. The method of claim 1, wherein the carbon fibers are activated at a first temperature in a range from 825° C. to 875° C. for a first duration in a range of 5 hours to 7 hours followed by a second temperature in a range from 925° C. to 975° C. for a duration in a range of 1 hour to 2 hours in carbon dioxide.

7. The method of claim 1, wherein the stabilized pitch fibers are carbonized and the carbon fibers are activated in a continuous process in carbon dioxide.

8. The method of claim 1, wherein the stabilized pitch fibers are carbonized and activated in a single step using potassium hydroxide at 700° C.

9. The method of claim 1, further comprising:
absorbing a selected gas with the activated carbon fibers; and
desorbing the selected gas from the activated carbon fibers by applying current to the activated carbon fibers.

10. The method of claim 1, wherein a weight loss of the activated carbon fibers relative to the stabilized pitch fibers after the carbonizing and the activating is at least 60%.

11. The method of claim 1, wherein a weight loss of the activated carbon fibers relative to the stabilized pitch fibers after the carbonizing and the activating is at least 70%.

12. A filtration or gas adsorption material comprising:
activated carbon fibers having diameters of 20 μm or less and a specific area of at least 1900 m²/g.

13. The material of claim 12, wherein the activated carbon fibers have an electrical resistivity in a range from 1 ohm-m to 1.3 ohm-m.

14. The material of claim 12, wherein the activated carbon fibers comprise large pores with diameters in a range from 200 nm to 400 nm surrounded by small pores with diameters of 100 nm or less.

15. The material of claim 12, wherein the activated carbon fibers comprise large pores with diameters in a range from 300 nm to 800 nm surrounded by small pores with diameters of 100 nm or less.

16. The material of claim 12, wherein the activated carbon fibers comprise pores with diameters of 2 microns and less.

17. A method of producing an activated carbon fiber material, the method comprising:
forming pitch fibers; and
simultaneously carbonizing and activating the pitch fibers into activated carbon fibers in an environment comprising carbon dioxide (CO₂) and water (H₂O).

18. The method of claim 17, wherein activating the pitch fibers forms the activated carbon fibers with a specific surface area of at least 1900 m²/g.

19. The method of claim 17, further comprising:
using the activated carbon fibers to adsorb a selected gas; and
desorbing the selected gas from the activated carbon fibers by applying current to the activated carbon fibers.

20. The method of claim 17, wherein forming the pitch fibers comprises melt blowing pitch into fibers with diameters in a range from 1 μm to 20 μm.
